(19) United States
(12) Patent Application Publication
(10) Pub. No.: US 2011/0226101 A1
(43) Pub. Date: Sep. 22, 2011

(54) Portioning machine

(75) Inventor: Thomas Völkl, Bruckmuhl (DE)

(73) Assignee: TVI Entwicklung & Produktion GmbH

(21) Appl. No.: 13/065,191

(22) Filed: Mar. 15, 2011

(30) Foreign Application Priority Data
Mar. 19, 2010 (DE) 102010012066.9
Aug. 27, 2010 (DE) 102010035657.3

(51) Int. Cl. B26D 7/08; B26D 7/32

(52) U.S. Cl. 83/19; 83/176

(57) ABSTRACT

In order to keep a portioning machine economical, a pre compression in longitudinal direction is maintained, but complexity is minimized on the portioning side in that preferably no portioning plate, in particular no portioning revolver is used but the cutting material (2) is moved forward in longitudinal direction (10) up to a stop from the forming tube (1), wherein the stop rotates e.g. as a stop plate (9) together with the blade (8) and thus on the same axis as the forming tube revolver (1). Thus, it is important that the rotating blade (8) is always kept tight at the forming tube revolver (1) and thin slices (2a) are prevented from adhering to the rotating blade (8).

### I. FIELD OF THE INVENTION

The invention relates to a portion machine for cutting off slices.

### II. BACKGROUND OF THE INVENTION

When a strand shaped cutting material with constant uniform cross section has to be cut into slices or portions with equal size and a minimum amount of leftovers shall be created, the task is relatively simple when only slices with a particular thickness have to be cut.

For this application so called slicers are available which are used for cutting up e.g. strands made from sausage, cheese or similar which always have the same cross section and have sufficiently large indigenous cross section stability.

Thus, the cutting material is sometimes advanced with its foremost face against a fixated stop whose distance from the end of the cutting blade is adjustable in order to vary the thickness of the slices and after each advance a slice is cut off through a rotating or oscillating blade until the entire cutting material is cut into slices.

Thus, the particular slices are typically captured one by one and removed. In a few cases the slices remain arranged lying on the cut side one after the other and in turn form a cut up strand or stick. The leftovers are being minimized by making the strand e.g. the sausage to be cut up longer and longer.

However, it is problematic when the cutting material on the one hand side has variable cross section with respect to size and shape and the cross section is not very form stable, like when cutting up fresh meat or fish, thus when cutting up a pork neck to form pork chops or similar.

Various methods are known to obtain slices with a predetermined target weight or target volume.

One method is to measure the cross section of the cutting material at as many locations as possible, e.g. through an optical touch free measurement method and to determine the necessary current slice thickness on this basis in order to arrive at the desired target volume for the slice.

However, when the cross section of the cutting material varies quickly, this yields slices with very different thicknesses for the same target volume which is typically undesirable for the consumer.

Furthermore this is also complex from a control point of view and also complex from a practical point of view, since in this case the cutting material is not in a completely enveloping container and slightly deforms during cutting, so that the cut off slice does not exactly have the target weight and the desired target shape due to the deformation.

Another method as it is described e.g. in DE 10 2004 041 915 takes the path to compress the cutting material in a forming tube with predetermined cross section at least in a longitudinal direction of the forming tube, strong enough so that the cutting material completely fills the cross section of the forming tube, and thus has a defined cross section and based on the known cross section, slices with uniform thickness are cut off.

In order to safely facilitate this object, the portion of the cutting material that is pushed forward beyond the blade plane is inserted into a portioning tube or portioning plate that is aligned with the forming tube, and the portion of the cutting material is circumferentially and on the end face supported at the portioning tube, so that neither the presently cutoff slice nor the rest of the cutting material can substantially deform or move out of the way during the cutoff process.

This way, portions are provided that are very precise with respect to weight and volume. However, the mechanical complexity for this is much greater than for a simple slicer, on the one hand side, because of the necessary compression of the cutting material with a relatively large force, at least in longitudinal direction, often additionally also in transversal direction, on the other hand, due to the required mechanism on the side of the cutoff slices, which typically requires a movable stop in the portioning tube or at the portioning plate, configured as a base, and thus the mechanical complexity is similar to the one at the cutting material side.

In particular however, the cycle time for producing a slice is relatively high, and depending on the cutting material, the ejection from the portioning tube or the portioning plate can present additional difficulties.

Portioning machines of this type are well suited for cutting up very large volumes from the same cutting material, e.g. pork neck, continuously over a long time with precise weight and/or with as little left over as possible.

Thus, it is also known to dispose at least the forming tube in a forming tube revolver, in which plural forming tubes are arranged. Thus, the forming tubes can have different cross sections and different sizes for different cutting materials. Preferably, each forming tube cross section is provided in the forming revolver twice, namely in an opposed configuration with respect to the center.

This facilitates to refill one of the two identical forming tubes with the same cutting material while a portioning is simultaneously performed out of the other forming tube.

A differentiation furthermore has to be made with respect to the forming tube, whether the cutting material does or does not include hard components, e.g. meat strands with and without bones, since depending on the percentage and structure of the bone portion, no longitudinal compression, but only a transversal compression or no compression can be provided in the forming tube, thus when a pork chop strand shall be cut up out of a forming tube of this type.

Machines of this type are therefore less suitable for applications in smaller butcher shops or in smaller meat packing plants with continuously changing cutting material and the machines are typically also too expensive to buy.

### III. DESCRIPTION OF THE INVENTION

### a) Technical Object

Thus, it is the object of the invention to provide a portioning machine, which operates very fast, provides single slice placement, and which is simple in configuration, economical to buy and easy to maintain, and which can still provide portioning with sufficiently precise weight, namely for cutting material with very different configurations.

### b) Solution

The object is achieved through the features of claims 1 and 16. Advantageous embodiments can be derived from the dependent claims.

Since the cutting device for a portioning machine includes a rotating blade which rotates in particular with the stop plate as the stop element about the identical axis, the configuration of the machine is highly simplified on the portioning side and the advantages of the pre deformation of the cutting material into a defined cross section and its volume determination through purely mechanical devices is maintained.

In case the form stability of the slice thus generated is not sufficient due to the consistency of the cutting material or due to the selected slice thickness, an additional portioning plate can be optionally used in which the circumference of the cut off slice is supported in order to improve the weight precision without making the configuration of the machine more complicated or complex since the portioning plate is a simple mechanical component with a pass through opening without additional components like ejectors, compressed air loading or similar.

Additionally when the rotation axis of blade and stop plate is identical with the rotation axis, thus the switching axis of the forming tube revolver, this yields a particularly compact configuration of the machine, in particular when the forming tube revolver is placed vertical, and this yields low technical complexity.

Thus, the blade is preferably configured disc shaped with a surface and extension in radial and in circumferential direction so that the cross section of the forming tube is covered in the cutting position by the blade after cutting off the slice, and thus a forward sliding of the cutting material in the forming tube is only facilitated when the rear edge of the blade in cutting direction has left the cross section of the forming tube again.

As soon as this is the case, however, the stop plate co-rotating with the blade which covers the rest of the circumference of the portion of the forming tubes in the revolver is below the cutting position and is used as a support for the cutting material which is pushed forward again.

In particular cases, however, also a blade can be advantageous which has a much smaller extension than the cutting material in circumferential direction with reference to the forming revolver which may facilitate starting to move the cutting material forward earlier and can thus reduce the cycle time.

The blade which is typically disc shaped is only ground sharp on one side, namely on the side facing away from the forming tube revolver and respectively includes a cutting edge at the forward and rear edge, namely preferably cutting edges with different configurations, one cutting edge for a cutting material with hard components like e.g. bones, the other cutting edge for a cutting material without such hard components.

The rotation direction of the blade and thus also the stop plate which always rotate jointly and synchronously is therefore selectable.

Since a pulling cut is preferred in particular for cutting soft components, the non serrated knife edge is configured as an edge that is spiral shaped from the inside to the outside with increasing curvature and thus preferably with a configuration so that at least three, better four cm of cutting length are covered per centimeter of cutting depth when cutting with this cutting edge.

Additionally a stop edge made from steel or another material can be provided at the edge of the face of the forming tube cylinder, wherein the edge is arranged opposite to the blade and the stop edge continuously regrinds the blade sliding over it.

Preferably the unit including the blade in the stop plate rotates continuously but not with constant speed.

In order to provide sufficient time for the press plunger to push the cutting material forward in longitudinal direction against the stop plate, the rotation speed is reduced after the blade has completely left the cross section of the cutting material to be cut up. This speed reduction can already begin before, namely as soon as the cutting edge of the blade has completely passed through the cutting material.

Sliding the cutting material forward should preferably be finished when 90° of rotation are still left until the next contact of the blade at the cutting material in order to provide time to the cutting material for a settling process and in order to provide time for the unit made from blade and stop plate to accelerate to cutting velocity again.

A control controls the speed of rotation of the unit including the blade and the stop plate and also the axial movement of the press plunger as a function of the rotational position of the unit including the blade and the stop plate.

In order to keep the blade directly at the face of the forming tube revolver that is oriented towards the cutting edge, the blade can either be kept so thick and thus so stable that it contacts the forming tube revolver with the necessary preload due to its inherent stability, or for a less stable blade this is achieved through a support plate which supports the blade on its side that is oriented away from the forming tube revolver and preloads the blade against the forming tube revolver. For this purpose the support plate includes spring elements which are oriented towards the blade which cause the preload. In order not to make the cutting process more difficult the support plate which certainly has to co-rotate with the blade has a smaller base surface than the blade and is sufficiently recessed at all locations with respect to the cutting edges of the blade.

Thus, also the support plate penetrates the gap between cutting material and disc when cutting the cutting material and thus makes the cutting process more difficult.

Thus, solutions are preferred which also support a thin inherently not very stable blade close to the face of the forming tube revolver at all times, e.g. magnets or openings that are disposed in the face of the forming tube revolver or openings which can be loaded with air suction, thus with a vacuum.

Thus, and in a supplemental manner thereto an axial support of the radially outer rim of the knife is provided in the forming tube revolver or in a sleeve outside of the forming tube revolver that co rotates with the blade. In order to prevent a distortion of the slices thus cut off through adhesion at the blade and/or at the conveyor belt moving the slices away various solutions can be implemented.

One solution provides that the conveyor belt includes protrusions or needles that protrude from its contact surface towards the slice, wherein the already cut off portion of the slice falls onto the protrusions so that the portion cannot slide away anymore. These protrusions or needles can also not be attached at the conveyor belt but can protrude against the slice e.g. between the particular belts from which a conveyor belt can be made.

Preferably protrusions or needles of this type should be configured to be pulled back.

The cutting material does not necessarily have to be pushed forward against a stop plate that co-rotates with the blade but e.g. also the removing conveyor belt can be used as a stop plate. Thus, the conveyor belt can be an endless circulating conveyor belt or a non endless conveyor belt which facilitates moving an additionally provided stop plate under the slice, wherein the stop plate then in turn supports the conveyor belt.

In the upward oriented contact surface of the conveyor belt for the slices an indentation can be configured which corresponds to the circumferential contour of the forming tube, e.g. of the largest forming tube that is provided and with a depth that corresponds to the thickness of the blade. The space that is required by the blade in axial direction when penetrating the cutting material is thus provided through the recess in the contact surface of the conveyor belt. This preferably requires a relative movement between the slice and the conveyor belt so that the blade penetrates the cutting material which can also cause a distortion of the slice.

Thus another option is to lower the conveyor belt initially at the penetration side by an amount that corresponds to the blade thickness when the blade penetrates the cutting material, instead of providing an indentation, and to subsequently lower the conveyor belt on the exit side of the blade on the cutting material, and to control this in a time coordinated manner with the blade passage through the cutting material.

A compressible layer can also be provided on the conveyor belt instead of a permanently formed indentation in the contact surface of the conveyor belt.

Furthermore indentations can be arranged at the bottom side of the blade oriented away from the forming tube revolver, so that the bottom side of the blade where the slices can adhere is preferably only made from bars or punctiform protrusions having the entire thickness, wherein the bars extend in particular in rotation direction. Through the reduction of the contact surface this also minimizes the risk of a slice adhering.

The conveyor belt can be adjustable with respect to its axial distance from the forming tube cylinder, either synchronously with the distance adjustment of the stop element or in a particular transmission ratio to the movement of the stop element or it can also be freely adjustable through a proper control.

The configuration of the machine is furthermore simplified in that the rotation drive of blade and cutting plate on one hand side and rotation drive of the forming tube revolver on the other hand side is implemented in a coaxial manner through the same drive shaft which is e.g. made from tubes running concentrically into one another, wherein the respective drive motors are also arranged in the tubes.

This is prevented by a transmission and force rerouting and simplifies the mechanical configuration.

Thus the inner most tube of the drive shaft, which can also be a massive shaft, is connected torque proof with the forming tube revolver while the outer tube that is arranged about the inner tube is connected torque proof with the blade and the stop plate.

The drive shaft and the associated motors are arranged on the back side of the cutting device, thus below the forming tube revolver, since the cutting device is arranged at the lower end of the forming tube revolver in order to use gravity for removing the cut off slices.

Only the axial distance adjustment between the stop plate and the blade is eccentrically arranged outside of the rotation axis and moves the outer tube which is preferably coupled with respect to the driving motor torque proof but longitudinally adjustable through a polygon profile e.g. through a star shaped profile.

The entire drive unit and also the control are disposed in a housing whose top side is disposed approximately at hip height of an operator standing in front of it and on whose top side the forming tube revolver is placed protruding upward vertically or at a slant angle.

Thus, the upper end of the forming tube into which new cutting material has to be inserted is disposed at a level which can still be reached by the operator.

The press unit which protrudes upward from the upper end of the forming tube revolver protrudes even higher in upward direction, wherein the press unit is typically a servo cylinder which, however, is pivotable in downward direction about its lower end relative to the support frame which attaches the servo cylinder to the housing in order to facilitate maintenance and cleaning.

Furthermore the housing has a base surface whose depth approximately corresponds to the diameter of the forming tube revolver and whose length is essentially defined by the extraction device, typically a conveyor belt onto which the cut off slices fall below the cutting position and through which the slices are moved towards processing.

This yields a very small foot print for the portioning machines which furthermore can be placed in close proximity to one another in a multiple arrangement since the loading is not only performed from the broad side, but also from the narrow side, namely the narrow side facing away from the extraction device.

In order to be able to configure the blade as thin as possible it is supported at its circumferential edge and at a support ring of the housing, while the stop plate can be configured sufficiently stable at its bottom side through bracing etc. and therefore does not require the support.

Also the configuration and the replacement of the forming tube revolver are configured as simple as possible.

The forming tube revolver has to be replaced now and then, either for cleaning purposes or because a forming tube revolver with other forming tube cross sections is required.

For a main application in a medium sized butcher store preferably a revolver with as many different forming tube cross sections as possible is used for different applications.

However, when several pieces of a continuous cutting material, e.g. pork chops are to be cut one after the other, using a forming tube revolver is recommended, wherein a suitable forming tube cross section is provided in the forming tube revolver at least twice preferably on sides that are arranged opposite to one another with respect to the rotation axis since this tends to reduce the dead times of the machine. While one of the two identical forming tubes is filled and is already being cut into slices, the other of the two identical forming tubes can be filled with the next cutting material.

However, for a large volume of identical cutting material a forming tube revolver is also useful in which all forming tube openings have equal sizes and dimensions, since then the operator can fill all forming tubes of the revolver which are subsequently cut up automatically one after the other so that the operator only has to refill after a rather long time period.

In order to make producing the forming tube revolver more economical, it is assembled from revolver discs axially lined up one after the other, wherein all revolver discs have identical aligned pass through openings configured as forming tubes and are coupled with one another in rotation through form locking through fit elements engaging one another.

In longitudinal direction the revolver discs are pressed against one another through a retaining rod, wherein the contract pressure in relationship to the pressure of the press plunger is selected so that excess air and also meat juice can be pressed from the filled forming tube through the gaps between the revolver discs in outward direction so that air and liquid enclosure are prevented during longitudinal compression in the forming tube, which lead to deviations of the actual volume of the generated slices from the target volume.

Besides the pass through openings configured as forming tubes arranged eccentric to its center the forming tube revolver has a central opening through which a retaining rod for compressing the revolver discs can be inserted from the top, wherein the retaining rod with its forward, then lower end is fixated, e.g. threaded into the upper end of the drive shaft for the forming tube revolver, wherein the drive shaft terminates slightly below the forming tube revolver.

Thus the retaining rod also runs through an adapter disc at the lower end of the forming tube revolver, wherein the adapter disc through its non circular outer contour is connected torque proof with the lowest revolver disc of the forming tube revolver and is also connected torque proof with the drive shaft for the forming tube revolver in assembled condition.

The retaining rod includes an expanded head at its upper end so that the retaining rod when threaded downward into the drive shaft with the expanded head which contacts the uppermost disc, presses the revolver discs downward against the drive shaft and/or the housing and thus sufficiently compresses the revolver discs The adapter disc is preferably fixated in longitudinal direction at the lower end of the retaining rod so that the retaining rod only has to be gripped at the end protruding from the forming tube revolver on top and disengaged for removing the forming tube revolver from the portioning machine, e.g. the retaining rod has to be rotated in disengagement direction until the fixation (e.g. bayonet lock or clamping lever etc.) is disengaged at the lower end opposite to the drive shaft.

Subsequently the retaining rod including the adapter disc has to be removed in upward direction from the forming tube revolver, thereafter the forming tube revolver has to be moved in a radial direction and removed from the portioning machine.

Depending on the choice of the forming tube presently used, in which the cutting material shall be compressed in longitudinal direction, a fitting press plunger has to be mounted at the lower end of the longitudinal press device which is typically a servo cylinder, wherein the cross section of the press plunger corresponds to the cross section of the forming tube used.

The change can be performed manually in that the press plunger and the press device include interlocking devices so that the press plunger only has to be inserted e.g. laterally and interlocked so that it already has its correct position in transversal direction with respect to the forming tube used.

Changing the press plunger can be automated partially or also completely.

In a first variant the different press plungers are moveably arranged on a stationary ring whose center is arranged remote from the rotation axis of the forming tube revolver and the ring section at the cutting position is part of the press plunger receiver for the press plunger.

Instead, the different press plungers can also be arranged at fixed positions of the ring and the ring can be arranged rotatable about its center.

The press plunger on the ring or the rotatable press plunger ring is then always rotated together with the forming tube by hand or also actuated by the control, e.g. through a form locking drive star profile, so that in the cutting position of the forming tube revolver at which the longitudinal press unit like e.g. the servo cylinder is disposed, a press plunger is always arranged which fits together with the forming tube arranged at this location.

The press plunger can be received manually or automatically by the longitudinal pressing device and can be used for longitudinal pressing.

The control which starts in the servo cylinder after cutting off each slice and moves it in longitudinal direction by a defined distance is also capable during initial longitudinal pressing of the cutting material to determine the length and thus the total volume of the cutting material by determining the position of the servo cylinder and as a function thereof to predetermine an optimum slice thickness in consideration of the parameters set by the user like band width of the weight or volume of the slices or similar in order to minimize the portion of leftovers or to have no leftovers at all.

A portioning machine of this type can be additionally varied and improved in many ways.

Thus in addition to the longitudinal pressing also a transversal pressing of the cutting material can be provided in the respective forming tube which is particularly advantageous when it is a cutting material which cannot be sufficiently compressed in longitudinal direction, e.g. cutting material including bones, like e.g. a strand of pork chops.

In order to provide transversal compression, the forming tube, preferably all forming tubes of a forming tube revolver are configured in two components in transversal direction, in that the outer circumferential piece of the forming tube opening which reaches into the outer circumference of the forming tube revolver is a separate component and sized and arranged so that it can penetrate into the forming tube opening in some places, wherein this can be performed over the entire length of the forming tube revolver.

This penetration can be performed through a pneumatic cylinder or servo cylinder. Preferably, however, a purely mechanical solution is desirable in order to reduce the complexity.

Since the transversal compression in rotation direction is only required in the cutting position or shortly before reaching the cutting position, a transversal compression plunger of this type can regularly protrude beyond the rest of the circumference of the forming tube revolver and can be automatically moved in radial direction into the cutting position through a stop that tangentially approaches the outer circumference in rotation direction of the forming tube revolver upon rotation of the forming tube revolver.

In order for the penetration to not always be performed with the same depth in spite of the stop that always remains in the same position, the transversal press plunger itself can be provided in two pieces in radial direction with compression springs there between.

Since the remaining free cross section of the forming tube changes this way, the longitudinal press plunger that is being used also has to be configured to be adapted to the cross section change.

This is preferably provided in that the longitudinal press plunger is also provided in two pieces in its cross section with springs there between which are then also being compressed through the penetration of the transversal press plunger.

Since the particular forming tubes in this case do not have a closed one piece circumference any more, a configuration with particular revolver discs is not necessary for manufacturing reasons anymore.

Instead a base element that is continuous over the entire length and includes outward open grooves of the forming tubes can be produced, while the transversal press plungers penetrating into these grooves radially from the outside can be produced separately.

While the gap between a transversal press plunger and the rest of the forming tube is sufficient for a transversal press plunger in order to press excess gas or also liquid from the forming tube to the outside during the compression, this is provided for a forming tube revolver configured from particular circumferentially closed revolver discs in that the revolver discs are adjacent to one another with a small distance of less than 0.1 mm from the radial portion of the forming tube opening to the outside.

Typically, the lowest revolver disc does not differ from the revolver disc disposed there above, or differs at the most through its thickness.

Namely an intermediary plate is typically inserted between the lowest revolver disc and the next revolver disc, wherein the intermediary plate only includes a pass through opening for the cutting material in the cutting position, while the forming tubes are closed through the intermediary plate at all other positions of the forming tube revolver.

Thus, the intermediary plate forms the bottom stop for the cutting material which is inserted into the forming tubes from the top in order to fill the forming tubes.

In order for the forming tube revolver to be reliably held at this rotation position after placing a particular forming tube into the cutting position, an interlocking can either be performed through form locking relative to the housing in each switching position, or the forming tube revolver is rotated through a drive that is configured self hemming, either from the central axle or also from a self hemming drive engaging the outer circumference of the forming tube revolver.

Another option is to use a disc shaped portioning revolver instead of a single portioning disc which is introduced at the cutting position, wherein the portioning revolver does not only include one pass through opening for temporary use in the cutting position, but also includes plural openings distributed over the disc circumference, wherein all openings have the same shape and size, namely according to the cross section in the cutting plane of the forming tube that is being currently used.

After the slice is cut off it is disposed in a pass through opening of the portioning revolver which is open at the top and at the bottom, however, in this case the cut off slice shall not immediately fall downward out of the portioning revolver at the cutting position.

The portioning revolver is rather closed at the cutting position at its bottom through a plate which contacts at this location, e.g. the stop plate.

Since the portioning revolver rotates about a rotation axis remote from the rotation axis of the forming tube revolver and the two revolver cross sections only overlap at the cutting position, the slice only falls out of the pass through opening of the portioning revolver when the portioning revolver is rotated forward into a drop off position in which the lower opening of the pass through opening is not closed e.g. by the stop plate any more.

Thus, for this purpose the portioning revolver is respectively cycled by one position after the slice is cut off, wherein the drop off at the drop off position not only has to be performed through gravity but can also be actively supported through a mechanical ejector or through compressed air.

In this solution the stop plate can stand still and can also extend continuously over the entire circumference of the forming tube revolver, thus the stop plate is not coupled with the blade in rotation direction.

It is another option to increase the through put in that the portioning machine includes plural, e.g. two forming tube revolvers adjacent to one another through which the slices of both forming tube revolvers are cut off by the same common cutting device, thus by a single jointly rotating blade.

Additionally devices like a stop plate, a portioning plate or a portioning revolver etc. are provided in turn.

The blade then certainly does not rotate about the rotation axis of one of the forming tube revolvers but about an axis which is disposed offset from all rotation axes of the forming tube revolvers, however, offset so that the blade covers the cutting position of each of the forming tube revolvers for each rotation.

In particular applications it can be desirable to cut slices off from a strand shaped cutting material at a slant angle, typically so that the slices become larger than the cross section of the cutting material.

This can also be achieved with the portioning machine according to the invention in that the rotation axis of the forming tube revolver is not identical or parallel with the rotation axis of the blade but arranged at a slant angle thereto.

In order to compensate for this arrangement a wedge shaped non moving cutting plate is arranged between the lower face of the rotatable forming tube revolver and the blade, wherein a pass through opening is provided in the cutting plate at the cutting position of the forming tube revolver, wherein the pass through opening coincides with the forming tube in the cutting position with respect to alignment, size and shape.

When operating a portioning machine, the cutting material after being inserted into a forming tube in the cutting position is not directly pressed by the longitudinal pressing plunger against the lower stop element and cutting the material off is begun immediately, but initially the cutting material is pressed forward and thus preferably not against e. g. the stop plate configured as a lower face stop, but either against the blade closing the forming tube or an intermediary plate which certainly has to be brought respectively into a corresponding closing rotation position for this purpose.

This has the advantage that the cutting material is then completely enclosed contrary to pre pressing against the stop plate where there is a gap between the stop plate and the lower end of the forming tube, at least corresponding to the thickness of the blade.

Subsequently the longitudinal press plunger is moved back again, the blade or intermediary plate serving as a stop is turned so that it releases the forming tube opening and the longitudinal press plunger is moved further forward so that it now pushes the cutting material for the final pressing further downward against the stop plate and compresses it and the process of cutting up can be commenced.

Preferably a volume determination for the cutting material is also performed during pre pressing by measuring the length of the compressed cutting material through position determination of the longitudinal press plunger and possibly the transversal press plunger, in case a transversal press plunger is provided and its position can be measured and based on the known cross section of the forming tube that is being used the volume of the cutting material is automatically computed by the control and preferably the volume information is used to determine the required slice thickness as a function of target weight and/or with the objective of minimizing the leftovers.

In order to avoid air inclusions or liquid inclusions when compressing the cutting material in a forming tube, the revolver discs of the forming tube revolver can also be stacked on top of one another without a gap when the pressure of the particular revolver discs relative to one another in axial direction is selected so that it is smaller than the pressure that occurs when longitudinally compressing in the forming tube so that air and liquid can exit from the forming tube through the gap between the revolver discs.

### c) EMBODIMENTS

Embodiments of the invention are subsequently described in more detail in an exemplary manner with reference to drawing figures, wherein:

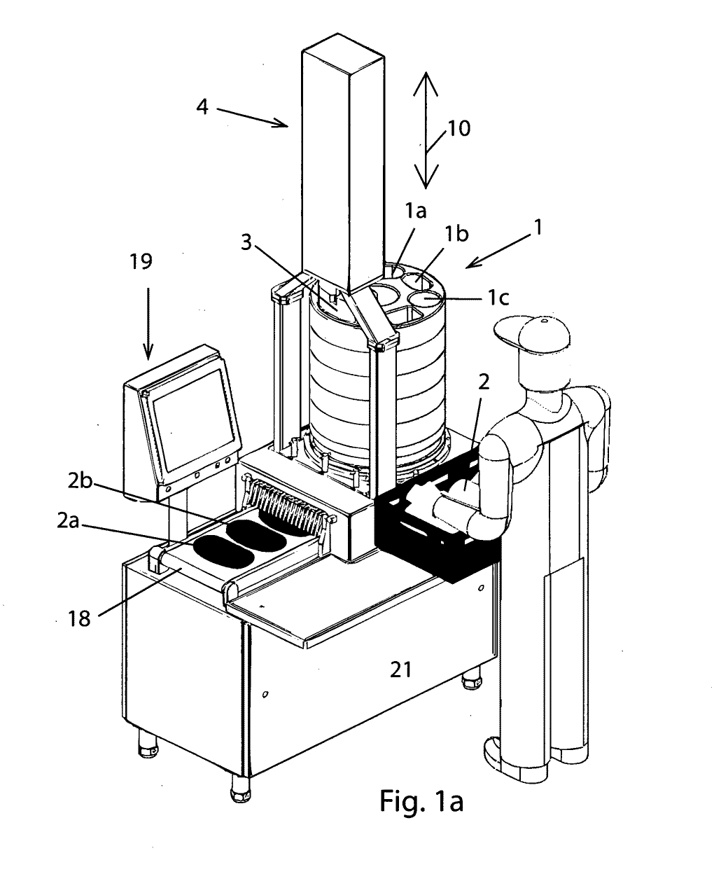

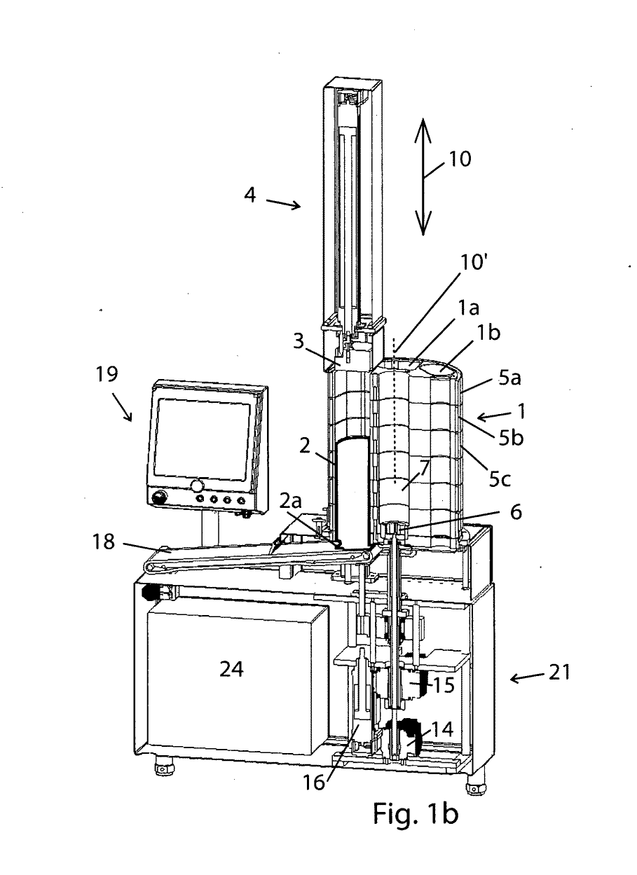

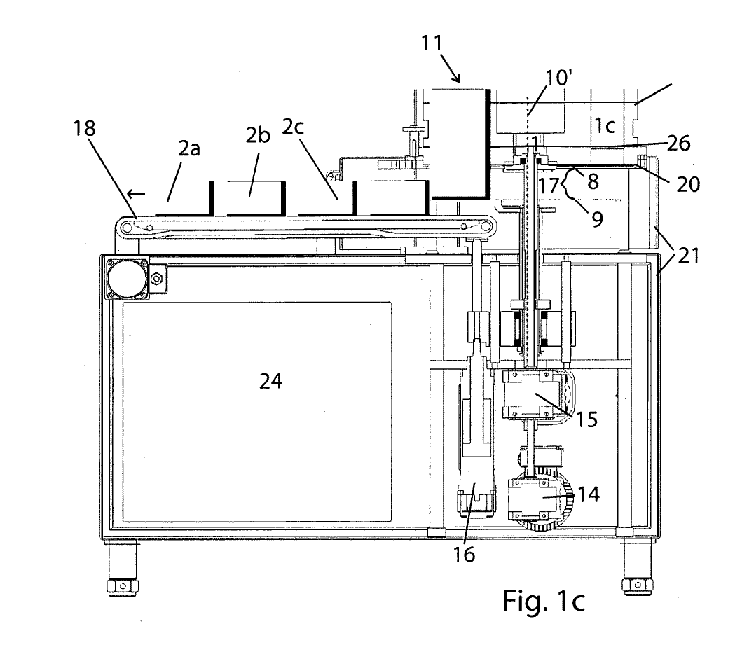

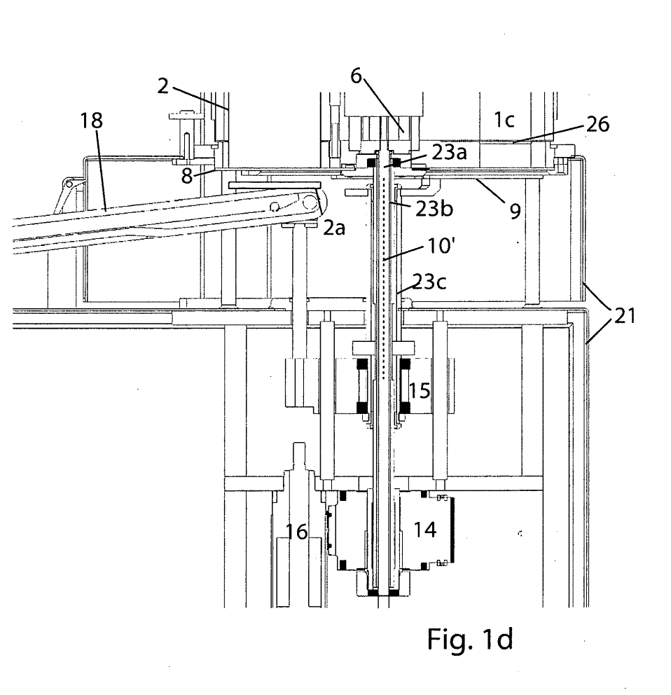

FIG. 1 illustrates the portioning machine in a perspective view and in sectional views;

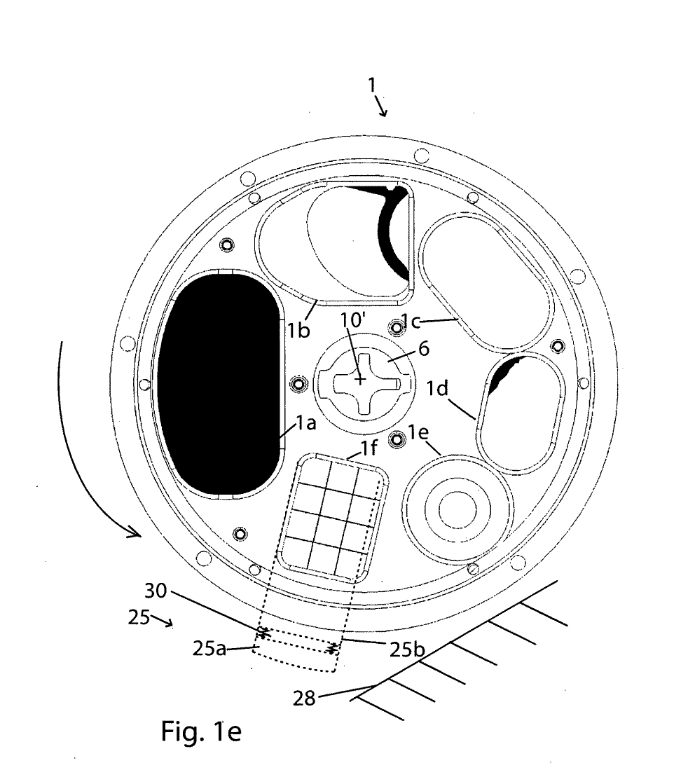

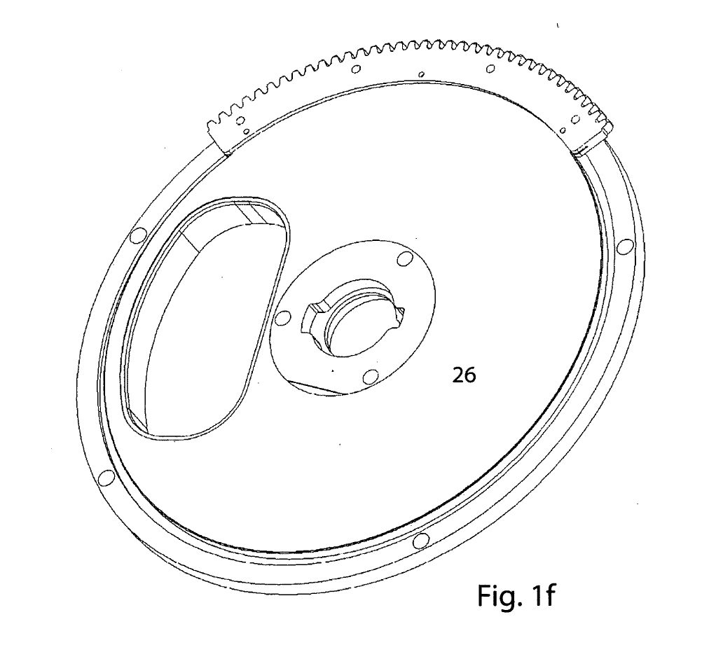

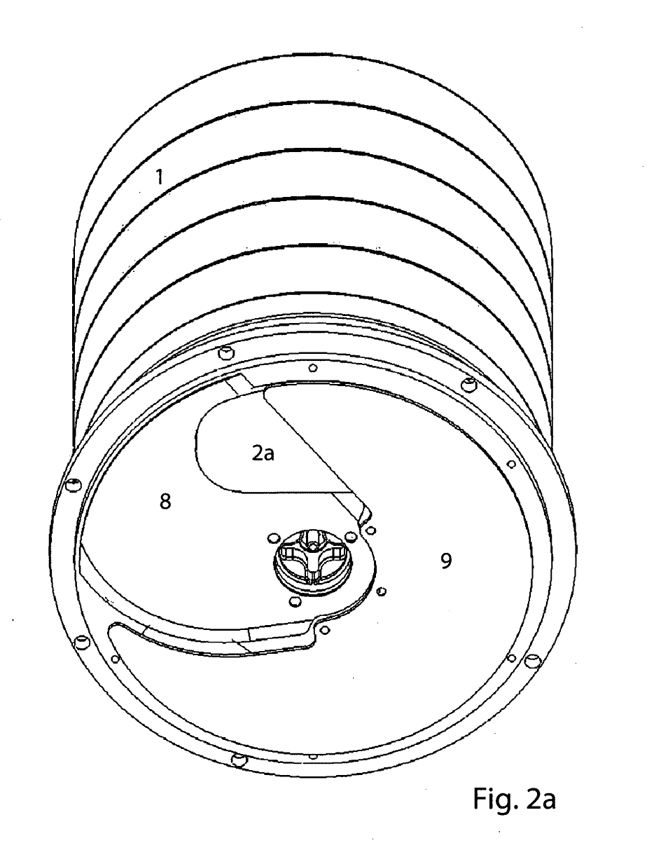

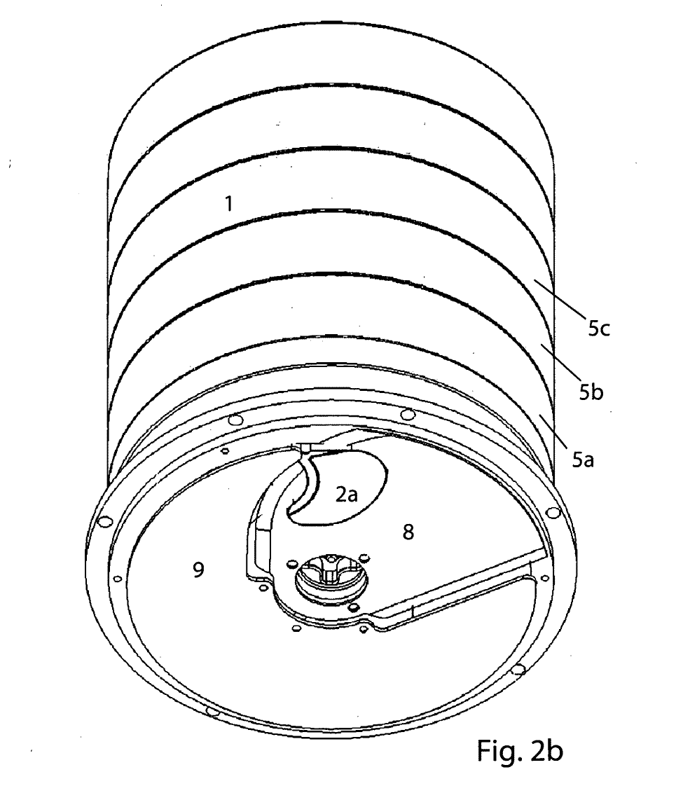

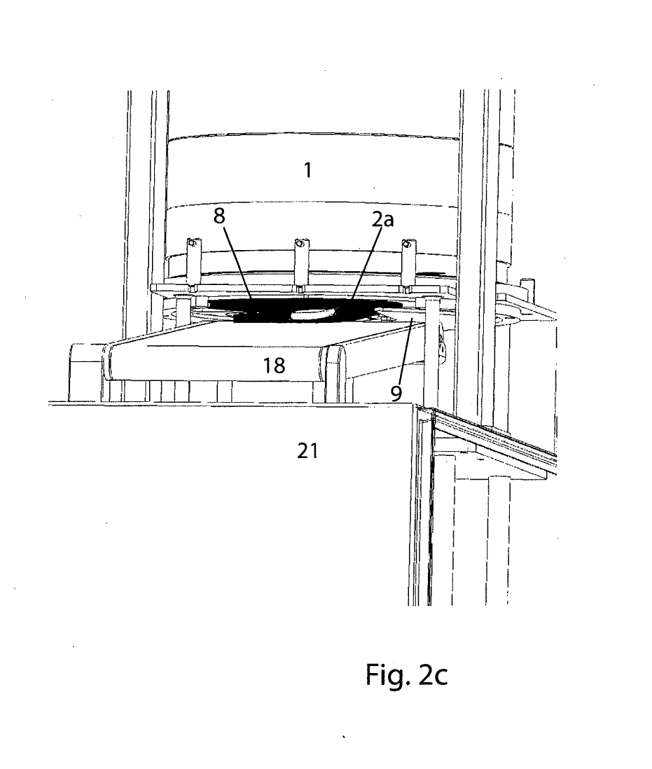

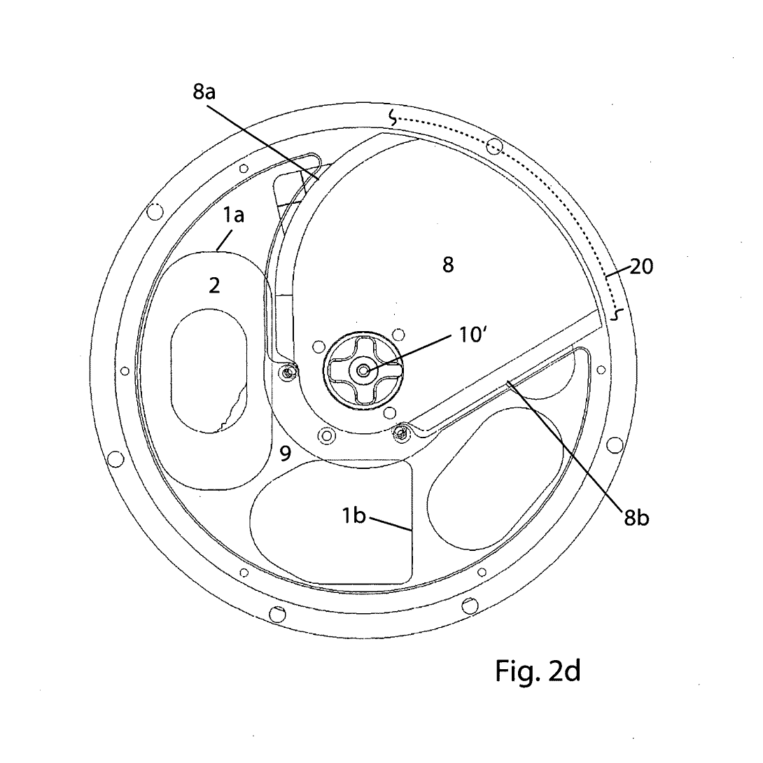

FIG. 2 illustrates the cutting process;

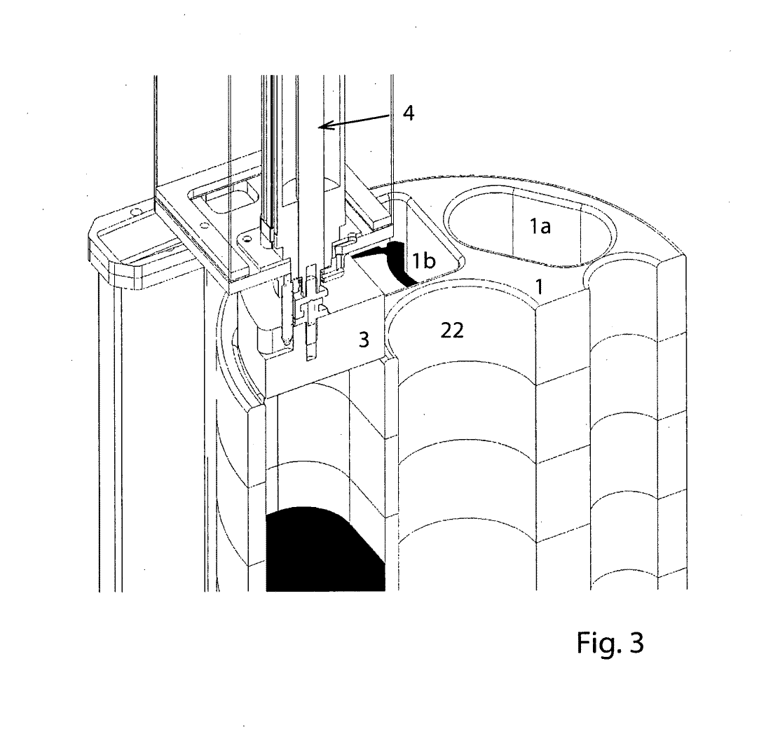

FIG. 3 illustrates the press plunger in detail;

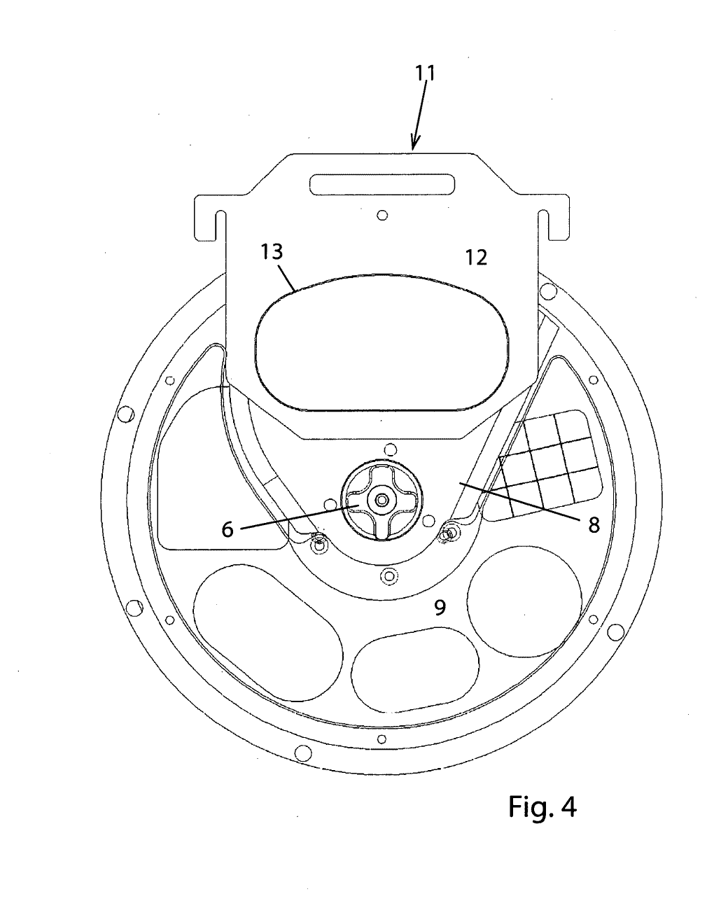

FIG. 4 illustrates the additional portioning plate;

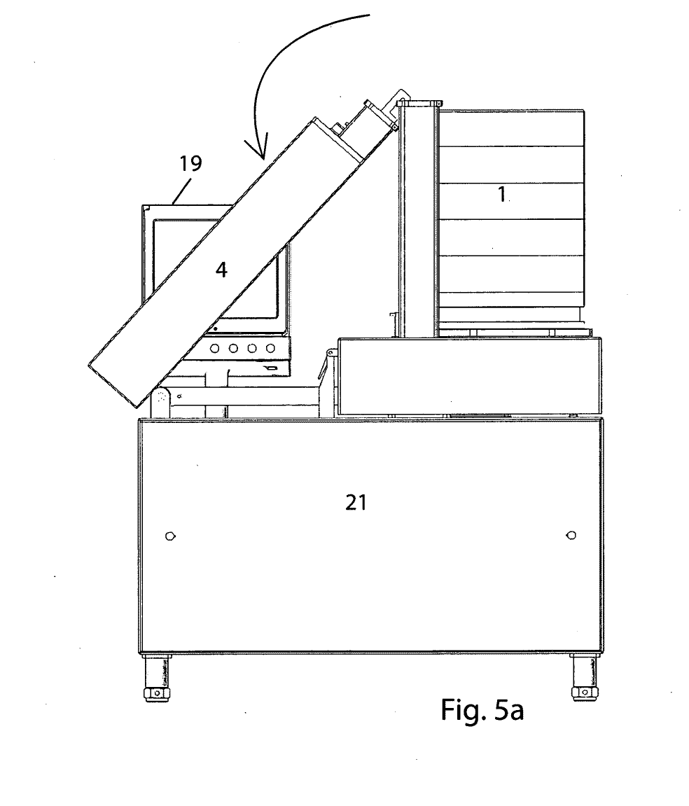

FIG. 5 illustrates particular views of the portioning machine;

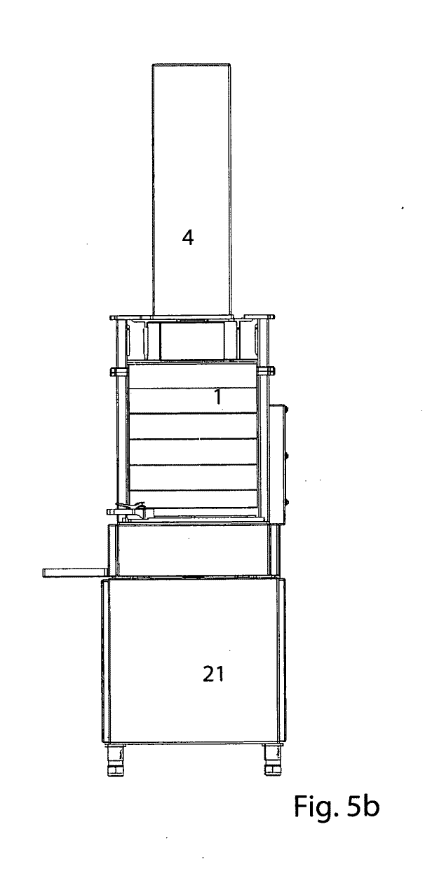

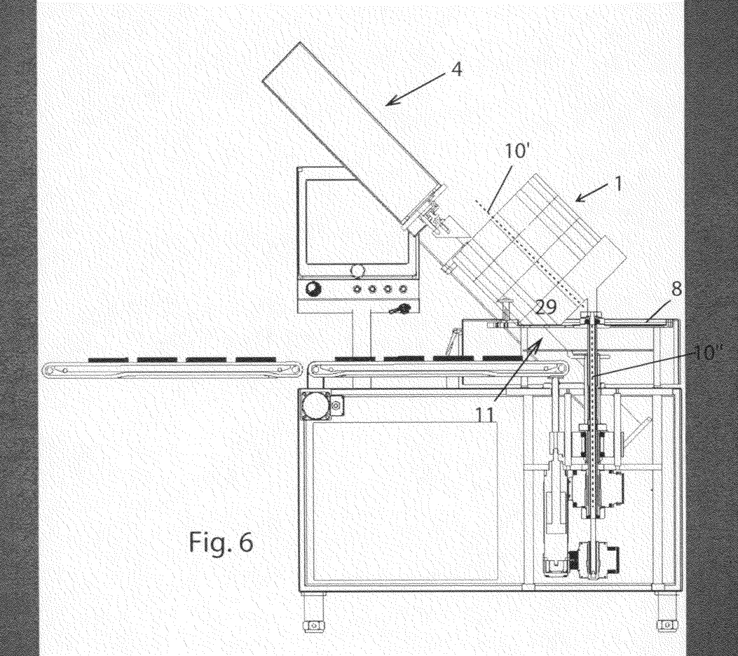

FIG. 6 illustrates a portioning machine for cutting at a slant angle;

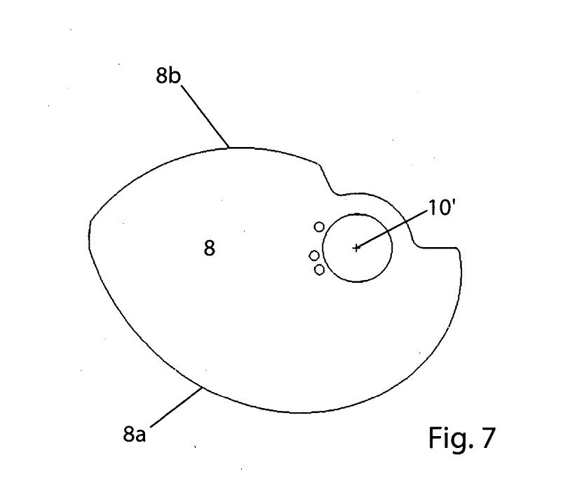

FIG. 7 illustrates a different blade configuration;

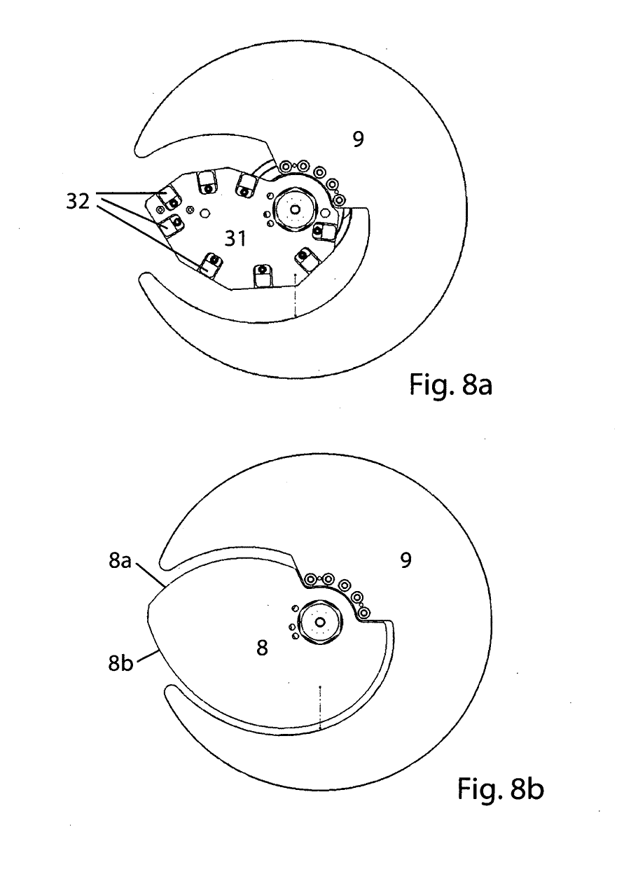

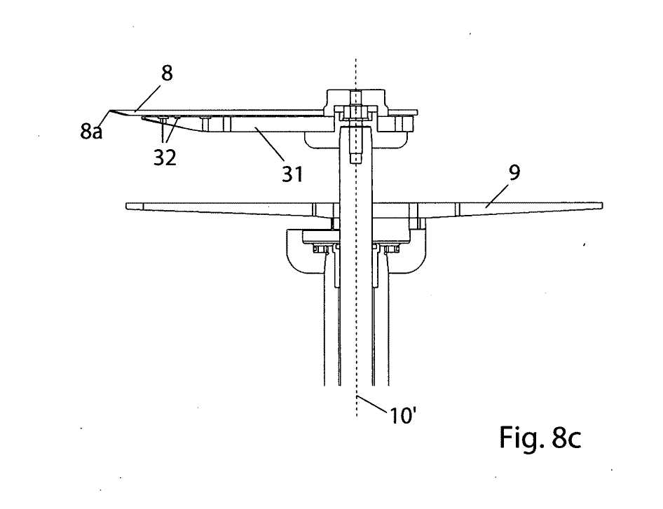

FIG. 8 illustrates a supported blade;

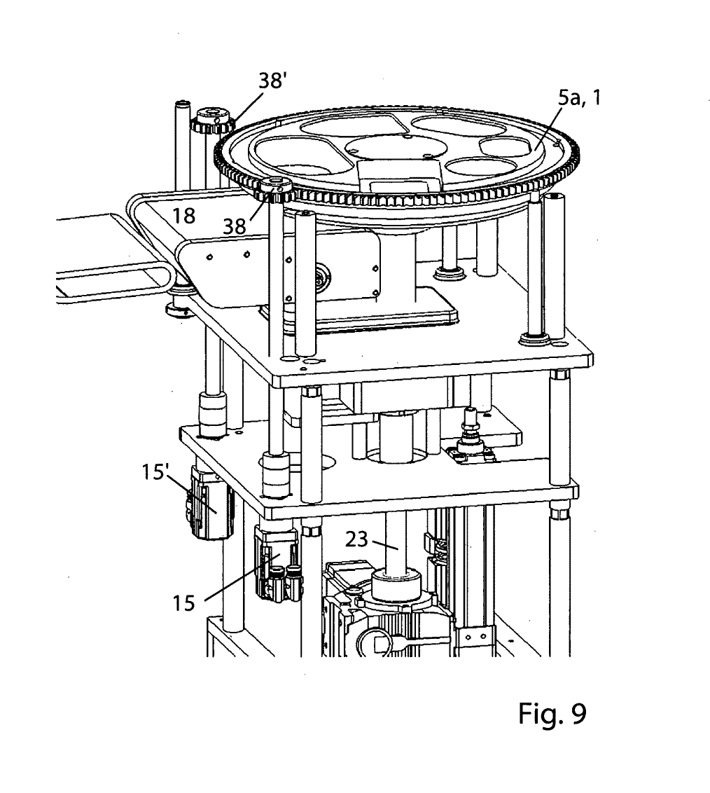

FIG. 9 illustrates a different configuration of the portioning machine; and

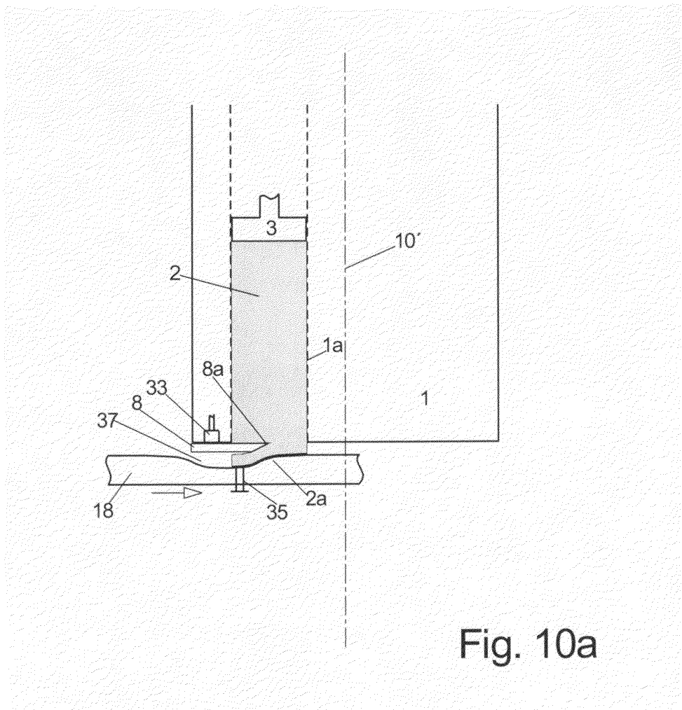

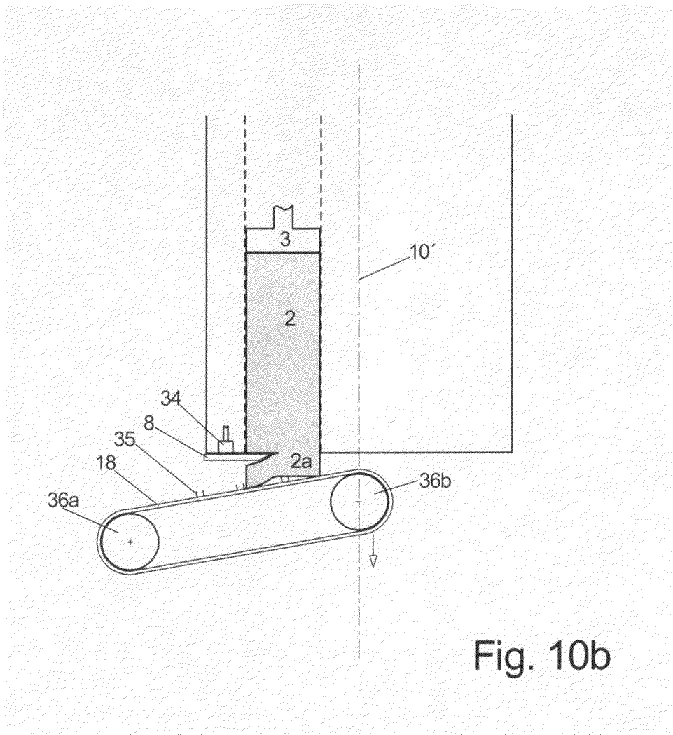

FIG. 10 illustrates particular cutting situations.

FIGS. 1a and 1b illustrate the entire portioning machine once in a perspective view and once in a vertical sectional view, wherein FIG. 1c and FIG. 1d are enlarged illustrations of the vertical sectional view through the lower portion.

As illustrated best in FIG. 1b the core of the portioning machine is an upright thus vertically oriented forming tube revolver 1 with pass through openings configured as forming tubes 1a, b which are eccentrically distributed about the circumference and respectively open on the top and on the bottom.

A strand shaped cutting material 2 is inserted into a forming tube, e.g. 1a and the forming tube revolver 1 rotatable about its longitudinal direction 10 configured as a rotation axis 10′ is subsequently rotated so that the filled forming tube is located under the servo cylinder 4 which is arranged only at one circumferential position, the cutting position 11 of the forming tube revolver 1, wherein the servo cylinder 4 forms the longitudinal pressing device.

A press plunger 3 is attached at the lower end of the servo cylinder 4, wherein the outer contour of the press plunger corresponds to the inner contour of the filled forming tube, e.g. 1a so that the cutting material 2 disposed in the forming tube that is filled into the respective forming tube through introducing the press plunger 3 through the servo cylinder 4 is compressed with a respective force in the longitudinal direction 10, since the cutting material 2 can exit from the lower open end of the forming tube only up to the stop plate 9.

During this longitudinal compression also the cross section of the not completely form stable cutting material 2 which was smaller than the cross section of the forming tube 1a upon insertion into the forming tube, is pressed apart radially far enough so that it completely fills the cross section of the forming tube and thus has a defined cross section in this longitudinally compressed condition.

As evident from FIG. 1c, a blade 8 rotates directly below the lower free end of the forming tube revolver 1 about the same rotation axis 10′ about which also the revolver 1 is rotatable and thus cuts a slice off from the cutting material 2 that protrudes downward from the forming tube, wherein the thickness of the slice corresponds to the distance 17 in longitudinal direction 10 between the blade 8 and the stop plate 9 disposed under the blade, whose distance from the blade 8 is adjustable.

For this purpose the blade 8 as evident from FIG. 2d only reaches from the rotation axis 10′ in one angular segment over the cross sections of the forming tubes, in particular up to the radially outer end of the revolver 1 to the outside and contacts a support ring 20 in the housing 21 with its outer edge so that the blade 8 can be configured as thin as possible.

Thus, the blade 8 includes circumferentially oriented forward and rear edges configured as cutting edges 8a, 8b, of which the cutting edge 8a is configured straight and the other cutting edge is configured arcuate convex.

Both are preferably ground on one side with a bevel at the bottom side, thus on the side oriented away from the forming tube revolver 1.

Thus in particular the cutting edge 8a is used for cutting soft cutting material 2 without bones or cartilage. The arcuate cutting edge 8b can also be configured undulated or serrated for cutting material 2 with hard components, e.g. with bones. The rotation direction of the blade 8 can be selected accordingly.

FIG. 2d furthermore illustrates that the stop plate 9 viewed from the top includes a recess which is slightly larger in circumferential direction than the surface of the blade 8 viewed in longitudinal direction 10, otherwise, however, it covers the bottom side of the forming tube revolver 1 at least beyond the radial portion of the forming tube openings 1a . . . and optionally it is also axially supported at its outer circumference like the blade 8.

The blade 8 and the stop plate 9 viewed in rotation direction always remain in the same relative position with respect to one another as illustrated in FIG. 2d and rotate together which, as illustrated best in FIGS. 2a and 2b in a view of the revolver 1 from the bottom, cuts off a particular disc 2a respectively one after the other from the cutting material 2 during each rotation.

Shortly after cutting off the slice 2a, the mostly plate shaped blade 8 supports the lower face of the cutting material 2 since the surface area of the cutting material is greater than the surface of the respective forming tube disposed in the cutting position 11.

When rotating the blade 8 and the stop plate 9 further, the overlap of the plate shaped blade 8 with the cutting material 2 ends after a particular rotation angle. Then only the stop plate 9 which is disposed lower than the blade 8 is disposed in the circumferential portion of the cutting material 2 disposed in the cutting position 11 so that the servo cylinder 4 is moved forward in a controlled manner by a defined distance during the time of rotation of the blade 8 and the stop plate 9 and presses the cutting material 2 further downward until it contacts the stop plate 9 again with its lower forward end.

This process has to be completed before the respective cutting edge 8a or 8b of the blade 8 has reached the outer circumference of the cutting material 2 again, wherein the cutting material protrudes from the forming tube and starts to cut off the next slice.

The blade 8 and the stop plate 9 rotate after the beginning of the cutting process continuously so that the control 24 of the machine controls the servo cylinder 4 as a function of the rotation position of the unit of the blade 8 and the contact plate 9, wherein the servo cylinder 4 has to push the cutting material 2 forward in longitudinal direction 10 at the right point in time and by the right distance.

The blade 8 and the stop plate 9 can rotate with a constant speed preferably, however, the speed is reduced as soon as the blade 8 has completely left the cutting material 2 in order to provide sufficient time for pushing the cutting material 2 forward again and pressing it against the stop plate 9.

Since the blade 8 and the stop plate 9 rotate about the same rotation axis 10′ about which also the forming tube revolver 1 is switched forward and eccentrically thereto only the servo cylinder 4 based on its function is oriented towards the cutting position with its press axis 11, this yields a particularly compact and particularly narrow configuration of the portioning machine and a comparatively simple engineering design.

As illustrated in FIGS. 1 the forming tube revolver 1 is placed on the top side of a housing 21 so that the forming tube revolver 1 is disposed approximately at hip level of an operator standing in front of it, wherein the operator is able to insert the next cutting material 2 into the upper end of an open forming tube.

The slices 2a . . . cut off by the blade 8 fall onto an approximately horizontally extending conveyor belt 18 which terminates under the cutting position 11 and which is preferably driven by the motor 14 for the rotation drive of the blade 8 and the stop plate 9 and which transports the slices falling onto it from below the revolver 1 into a direction for further processing.

The machine is very narrow in particular viewed in longitudinal direction of the conveyor belt 18 as illustrated best in FIG. 5b since the width hardly protrudes beyond the diameter of the forming tube revolver 1.

This way plural portioning machines can be set up adjacent to one another since filling the revolver 1 does not have to be performed from the longitudinal side as illustrated in FIG. 1a but can also be performed from the narrow back side facing the conveyor belt 18.

FIG. 5a illustrates in this context that the servo cylinder 4 which protrudes far upward beyond the upper end of the revolver 1 can be folded about its lower end for maintenance and repair purposes.

The input unit 19 arranged in side view next to the revolver 1 and above the conveyor belt 18, wherein the input unit also includes a screen and buttons configured as input elements, through which e.g. the forming tube to be operated is selected, the slice thickness is predetermined and similar, can also be operated from the forward face side.

FIG. 2a in a top view in longitudinal direction 10 of the forming tube revolver 1 illustrates that the forming tube revolver 1 can include forming tubes 1a-1f which in this case respectively have a different contour and size for different cutting material.

Thus, the forming tube 1a can be used for cutting up large schnitzels; the forming tube 1b however can rather be used for cutting up a string of pork chops.

The smaller forming tubes 1c and 1d with slotted hole shapes are used for cutting up meat strands with smaller cross sections than the products to be used in 1a.

The round cross section of the forming tube le is used for so called balls, a particular substantially ball shaped muscle strand.

The rectangular forming tube 1f is preferably used for cutting up meat cubes which are produced through blades that are provided like a grid in cross section, wherein the blades are either fixated in the lower end of the forming tube 17 or also in a portioning plate 12 which is radially insertable between the blade 8 and the stop plate 9.

In practical applications it has also proven useful that two respective coinciding forming tubes are provided in the same forming tube revolver 1 in the group of differently shaped and sized forming tubes 1a . . . and thus preferably with respect to the rotation axis 10′ on sides opposite to one another.

Thus, it is facilitated that during cutting up a cutting material in one of the two identical forming tubes the other identical forming tube disposed remote from the cutting position 11 can already be filled with the next cutting material.

Still depending on the application or also for cleaning purposes, the forming tube revolver 1 sometimes has to be removed from the portioning machine which can be a difficult task in view of a weight of the revolver typically made from plastic material in the range of 70-80 kg.

In order to facilitate this, different measures were taken.

On the one hand side the revolver 1 is made from plural revolver discs 5a, b, c . . . disposed on top of one another in longitudinal direction, wherein each of them is 10 cm thick and configured identical with respect to the pass through openings configured as forming tubes 1a .

Placed on top of one another the revolver discs 5a, b . . . are secured in a form locking manner in rotation direction relative to one another through fit elements engaging one another in axial direction.

The revolver discs 5a, b are pressed against one another in longitudinal direction 10 through a retaining rod 7 reaching through the central opening 22 over the entire length, wherein the retaining rod with its expanded end contacts the upper face of the revolver 1 and is connected with its lower end through an adapter disc 6 with the upper end of the drive shaft 23 which is arranged on the rotation axis 10′ in alignment with and below the forming tube revolver 1 and on which the rotation drive of the blade 8 and the stop plate 9 is caused and also the rotating shift movement of the revolver 1.

Thus the threaded in retaining rod 7 presses the revolver discs 5a, b against one another in longitudinal direction 10 so that after disengaging the threaded connection of the retaining rod 7 by gripping and rotating the upper end of the retaining rod 7 which protrudes upward out of the revolver 1 the retaining rod 7 including the adapter disc 9 which causes the transmission of the rotation of the drive shaft 23 to the lower end of the forming tube revolver 1, can be pulled out in upward direction and the forming tube revolver 1 can subsequently be slid off the housing 21 in radial lateral direction with respect to the rotation axis 10′.

In order for the cutting material not to slide out of the lower open end of the forming tube up to the housing when filling new cutting material 2 into an empty forming tube, e.g. 1c, thus remote from the cutting position 11 an intermediary plate 26 is provided between the lowest revolver disc 5a and the next revolver disc 5b disposed there above, wherein the intermediary plate 26 is illustrated as a separate component e.g. in 1f.

The intermediary plate 26 typically closes all forming tube openings besides the ones in the cutting position 11. Therefore the intermediary plate 26 only has one pass through opening which is normally arranged in the cutting position 11 and which corresponds to the largest pass through opening provided in a forming tube revolver.

Preferably the intermediary plate 26, however, is not connected torque proof with the rest of the forming tube revolver 1 but rotatable through the teething illustrated e.g. at its outer circumference about the rotation axis 10′ of the forming tube revolver 1 independently from the forming tube revolver 1.

Thus the intermediary plate can be rotated e.g. so that it closes the forming tube opening in the cutting position which is helpful e.g. for pre compressing a cutting material in the cutting position before beginning to cut up the cutting material.

The controlled rotation drive through the teething at the outer circumference is then performed through a sprocket which engages the teething and which is not illustrated, wherein the sprocket is driven through a motor which is controlled by the control of the machine.

The FIGS. 1b and 3 further illustrate that the press plunger 3 can be completely run out of the upper end of the respective forming tube through servo cylinder 4 and can be removed from the servo cylinder 4 in order to replace it with another press plunger respectively fitting the form and size of the forming tube of the forming tube revolver 1 currently used.

FIGS. 1b-1d illustrate the drive mechanics in the housing 21 below the forming tube revolver 1.

The drive shaft 23 includes two tubes 23a, b running into one another in a concentric manner, wherein the tubes are arranged in longitudinal direction 10 on the rotation axis 10′ and are drivable respectively separately about their rotation axis 10′.

The inner tube 23a is connected torque proof with its upper end with the adapter disc 6 which is configured at its outer circumference non circular, in particular star shaped and engages in a form locking manner in a respective inner circumference of the lowest disc of the forming tube revolver 1 and transfers the rotation of the inner tube 23a to the forming tube revolver 1 in order to shift the forming tube revolver 1 forward in order to bring another forming tube into the cutting position 11 below the servo cylinder 4.

For this purpose the inner tube 23a is driven by the motor 15 for rotating the revolver 1, wherein the revolver 1 is concentrically located on the rotation axis 10′.

The outer tube 23b is connected torque proof with the replaceable blade 8 on the one hand side and connected on the other hand side with the stop plate 9 and is caused to rotate through the motor 14 for the blade rotation which is also concentrically located on the rotation axis 10′ and which can also simultaneously provide the rotation drive for the conveyor belt 18 for removing the cut off slices 2a . . . , wherein the conveyor belt only has to move when slices 2a . . . are being cut off through the rotating blade 8.

An actuation cylinder 17 which is arranged eccentric to the rotation axis 10′ moves the outer tube 23b in longitudinal direction 10, wherein the stop plate 9 and the blade 8 are connected torque proof with the outer tube 23b which is supported on the inner tube 23a and relative to the motor 14 moveable in longitudinal direction 10.

FIG. 4 illustrates the additional option of a portioning plate 12 in a view of the forming tube revolver 1 from below, wherein the portioning plate can be optionally inserted from the radial outside in the elevation range between the blade 8 and the stop plate 9 at the cutting position 11.

The portioning plate 12 includes a pass through opening which is continuous form the top to the bottom and configured as a portioning opening 13 whose contour corresponds at least to the shape and size of the contour in the forming tube currently used.

A portioning plate 12 of this type is being used when there is the risk due to the thickness of the desired slices and/or the lack of form stability of the cutting material 2 that the portion of the cutting material 2 protruding downward from the forming tube and not supported at the circumference any more is deformed too much before or during cutting off the slice 2a which causes the form stability and volume stability of the slice 2a not to be sufficiently provided any more.

The use of the portioning plate 12 which should certainly be provided according to the number of the differently shaped forming tubes in respective variants, this occurrence is prevented, wherein the natural thickness of the portioning plate 12 predetermines the minimum adjustable distance between the blade 8 and the stop plate 9.

Thus, the downward protruding portion of the cutting material 2 is not always enclosed by the portioning plate 12 over the entire elevation range between the blade 8 and the stop plate 9, but it is enclosed over a substantial portion of the distance.

FIG. 6 illustrates a portioning machine which differs from the machine of FIGS. 1 in that the rotation axis 10′ of the forming tube revolver 1 and thus also the extension of the servo cylinder 4 are oriented at a slant angle to vertical, while the rotation axis 10″ of the blade is still oriented vertical.

Thus, slices are cut off in the cutting position at slant angle to the longitudinal direction of the cutting material and thus slices are obtained which are larger than the normal cross section of the cutting material.

In order to facilitate this a wedge plate 29 is arranged as a compensator for the angular offset between the rotation axis 10′ of the forming tube revolver 1 and the rotation axis 10″ of the blade 8 at the lower face of the forming tube revolver 1, wherein the wedge plate does not co-rotate with the forming tube revolver 1, but is fixated and is configured wedge shaped viewed from the side in the cutting position 11 and fills the intermediary angle between the lower face of the forming tube revolver 1 and the blade plane.

In this portion the wedge plate 29 also includes a pass through opening which is aligned with the pass through opening of the forming tube arranged in the cutting position 11 and with the respective form and size.

Accordingly in this case only the forming tube revolver 1 can be used either with a plurality of identical forming tube openings or a new wedge plate 29 with a respective pass through opening has to be installed for any other forming tube opening that is being used in the cutting position.

Furthermore with respect to FIG. 1e also the option of transversally compressing the cutting material in a forming tube is schematically illustrated which is implemented in FIG. 1e only in the forming tube 1f; however this could also be provided for each of the forming tubes of a forming tube cylinder 1.

A transversal press plunger 25 is configured from the thickest location in circumferential direction of the forming tube opening at the radially outer portion of the forming tube revolver 1, wherein the transversal press plunger 25 is retractable and extensible radially in a direction towards the forming tube opening and protrudes over the rest of the circumference of the forming tube revolver 1 in a radial direction and which is furthermore sub divided in its radial extension into two components 25a, b connected with one another through compression springs 30.

A stop 28 tangentially approaching the outer circumference of the forming tube revolver 1 is arranged in rotation direction of the forming tube revolver 1 shortly before the cutting position 11 and in the cutting position 11, wherein the stop 28 presses the circumferential surface of the transversal press plunger 28 radially inward due to the slanted position of the stop 28 when the forming tube If configured with a transversal plunger 25 is rotated into the cutting position 11 and thus the cutting material received in the forming tube if is compressed in radial direction, thus in transversal direction of the cutting material with a force which is a function of the spring coefficient of the compression springs 30 and thus of the position of the stop 28.

FIG. 8 illustrates an asymmetric shape of a plate shaped blade 8 which is configured approximately elliptical with a rotation axis 10′ outside of the center.

Two cutting edges 8a, b are configured at the blade 8, wherein both cutting edges are convex, however at the cutting edge 8b which is typically the serrated cutting edge for cutting material with bones, the curvature radius is constant, wherein the cutting edge 8b extends at an acute angle to the radial direction.

The cutting edge 8a, however is much longer, thus approximately twice as long and has a decreasing curvature from its point that is most proximal to the rotation axis 10′ to its outermost point, thus an increasing curvature radius. This provides a pulling cut when used in the cutting material.

It is illustrated in FIGS. 8 how the blade 8 can be pressed upward against the lower face of the forming tube revolver 1 from below through a support plate 31. FIG. 8c only illustrates the blade 8 rotating about the rotation axis 10′ in a vertical sectional view and the support plate 31 disposed there under and co rotating with the blade 8 synchronously, wherein spring elements 32 are configured in the top side of the support plate, wherein the spring elements press the blade 8 from the solid support plate 31 in upward direction against the forming tube revolver 1 which is not illustrated. At a distance below and also rotating about the rotation axis 10′ the stop plate 9 is visible in turn.

FIG. 8b illustrates the blade 8 that is arranged in the blade recess of the stop plate 9 in a top view from above, and FIG. 8a illustrates the support plate 31 which is visible after the blade 8 is removed. From this it is evident that the support plate 31 has a smaller base surface than the blade 8 and is recessed everywhere with respect to its cutting edges 8a, b.

FIG. 9 illustrates a configuration of the portioning machine that differs e.g. from FIG. 1d with respect to the rotation drive of the particular components.

In this embodiment the central drive shaft 23 only causes the rotation drive of the blade 8 and the stop plate 9 and the adjustment of their axial distances from one another. The rotation drive of the forming tube revolver 1 of which only the lowest revolver disc 5a is illustrated is performed through an exterior teething at the revolver disc 5a, wherein a sprocket 38 engages the outer teething, wherein the sprocket is directly driven by a motor 15.

An additional portion 15′ is illustrated in the rear portion, wherein the additional portion is configured to drive an additional sprocket 38′ in a controlled manner proximal to the outer circumference of the forming tube revolver 1 which is used for driving the intermediary plate 26 in rotation which is not visible in this figure and which has to be rotatable relative to the forming tube revolver 1.

FIGS. 10 furthermore illustrate options to compensate for the thickness of the blade 8 penetrating the cutting material 2.

Thus, a conveyor belt 18 is used as a stop element for the cutting material 2 to be cut up and protruding from the forming tube 1a, wherein the conveyor belt 18 is an endless circulating conveyor belt or a non endless conveyor belt that is movable back and forth.

In order to be useable as a stop element, the lower surface of the cutting material 2 contacts the top side of the contact surface of the conveyor belt 18 before cutting off a slice 2a.

When the blade 8 with its non negligible thickness laterally penetrates the cutting material 2, the already cut off portion of the slice 2a is moved downward by the thickness of the blade 8. In order to compensate for this, an indentation 37 is arranged in FIG. 10a in the top side of the conveyor belt 18, wherein the depth of the indentation corresponds to the thickness of the blade 8. The cross sectional shape corresponds to the cross section of the forming tube 1a that is currently being used or of the largest forming tube 1a that is provided in the forming tube revolver 1. When the blade 8 increasingly penetrates the cutting material 2, in FIG. 10a from the left to the right also the conveyor belt 18 whose indentation 37 initially was completely positioned left of the cutting material 2 is increasingly moved to the right by the same amount, so that a portion of the recess 37 is disposed under the forming tube 1a with the cutting material 2, wherein the portion is identical with the portion of the blade 8 which is presently disposed in the cross section of the forming tube 1a.

The disadvantage of the solution is that a relative movement between the conveyor belt 18 and the already partially cut off slice 2a is required which can lead to a fold up or distortion of the cut off portion of the slice 2a.

This problem can be solved e.g. in that the conveyor belt 18 viewed from above is made from belts disposed adjacent to one another with a space there between and wherein needles 35 protrude in the intermediary spaces in upward direction beyond the contact surface of the conveyor belt 18 and thus in the cross sectional portion of the forming tube 1a. The cut off portion of the slice 2a falls onto the needles 35 and is retained by the needles 35. The needles 35 do not move with the conveyor belt 18 for a relative movement between the conveyor belt 18 and the slice 2a, but they are arranged at a fixed position, however so that they are configured to be pulled downward in extension direction out of the slice 2a which is necessary to transport the slice 2a away through the conveyor belt 18 after complete cut off.

FIG. 10b illustrates a solution in which the conveyor belt 18 used as a stop element does not have to perform a sliding motion with its contact surface relative to the slice 2a during the cutoff of the slice 2a from the cutting material.

In this case the conveyor belt 18 which is an endless conveyor belt 18 running around two pulleys 36a, b which, however, is not a mandatory requirement for the solution, has a flat top side configured as a contact surface, thus without the indentation according to FIG. 10a.

The elevation compensation when the blade 8 penetrates is provided in that the conveyor belt 18 is initially increasingly lowered on the penetration side of the slice 2a until a lowering according to the thickness of the blade 8 is achieved and subsequently or simultaneously therewith the other end of the conveyor belt which is most proximal to the exit location of the blade 8 from the cutting material 2 is also lowered until the lowering is achieved. In the present case the pulley 36a can be initially lowered and subsequently the pulley 36b can be lowered in order to accomplish this.

Also here the needles 35 which can also be directly arranged on the contact surface of the conveyor belt 18 in this case, or which can protrude through the conveyor belt 18, can be provided, which however, is mostly not required due to a lack of a relative movement between the conveyor belt 18 and the slice 2a while the slice 2a is being cut off. However, if this is the case the needles 35 should also be configured so that they can be pulled back out of the slice 2a.

FIGS. 10, however, illustrate options how the blade 8 can be supported at the lower face of the forming tube revolver 1, possibly in contact so that no cutting gap occurs there between and without requiring a support of the blade 8 at the side facing away from the forming tube revolver.

FIG. 10a illustrates magnets 33 that are integrated in or proximal to the lower face of the forming tube revolver 1, wherein the magnets constantly attract the blade 8 which is typically made from magnetic material like e.g. steel, and wherein the magnets retain the blade at the face of the forming tube revolver 1 in spite of the sliding movement along the face.

The vacuum openings 34 illustrated in FIG. 10b fulfill the same purpose, wherein the vacuum openings constantly pull the plate shaped thus flat blade 8 against the face of the forming tube revolver 1 through air suction during the cutting operation and prevent a cutting gap there between.

### Reference Numerals and Designations

1 forming tube revolver
1a, b . . . forming tube, forming tube opening
2 cutting material
2a, b slice
3 longitudinal press plunger
4 servo cylinder
5a, b revolver discs
6 adapter disc
7 retaining rod
8 blade
8a, b cutting edge
9 stop plate
10 longitudinal direction
10′, 10″ rotation axis
11 press axis, cutting position
12 portioning plate
12′ portioning revolver
13 portioning opening
14 blade motor
15 revolver motor
16 actuation cylinder slice thickness
17 distance
18 conveyor belt
19 input unit
20 support ring
21 housing
22 central opening
23 drive shaft
23a, b tube
24 control
25a, b transversal plunger
26 intermediary plate
27 gap
28 stop
29 wedge plate
30 compression spring
31 support plate
32 spring element
33 magnet
34 vacuum openings
35 needles
36a, b pulleys
37 indentation
38, 38′ sprocket

1. A portioning machine for cutting a strand shaped cutting material (2) into slices (2a, b . . . ) preferably with identical volumes, comprising:
an upward forming tube revolver (1) in which plural forming tube openings (1a, b, c) extending in longitudinal direction (10) of the forming tube revolver (1) which are open on a top and on a bottom are arranged for receiving the cutting material (2);
a longitudinal plunger (3) that is loadable with a force and moveable in the longitudinal direction (10) and arranged at a circumferential location, the cutting position (11) for penetration into the forming tube (1 a) and for longitudinal compressing and moving the cutting material (2) arranged therein forward to a cutting side;
a cutting device at a lower end of the forming tube revolver (1) including a rotating blade (8);
an axial stop element for the cutting material that is adjustable with respect to its 1.3 distance from the forming tube revolver (1) on the side of the blade (8) that is opposite to the forming tube (1); and
a conveying device for the cut off slices (2a, b . . . ),
wherein the blade (8) is driven in rotation about an axis that it parallel to the rotation axis (10′) of the forming tube revolver (1).

2. The portioning machine according to claim 1,
wherein an axial distance between the rotating blade (8) and the stop element is clear and in particular does not include a portioning plate in the vicinity of the forming tube opening (1a) disposed in cutting position and/or,
wherein the blade (8) rotates about the rotation axis (10′) of the forming tube revolver (1) and/or,
wherein the cutting edge of the blade (8) is only ground on one side on the side facing away from the forming tube revolver (1).

3. The portioning machine according to claim 1,
wherein the blade (8) only includes protrusions or bars with the full thickness of the blade (8) in a portion behind the cutting edge and the blade (8) includes indentations there between on the contact side towards the cut off slice, and/or
wherein the blade (8) includes a blade thickness of at least 5 mm.

4. The portioning machine according to claim 1,
wherein the blade (8) includes a serrated cutting edge (8b) and a non serrated cutting edge (8a) and/or,
wherein a cutting edge, in particular the non serrated cutting edge includes a spiral shape with a radius that increases in size in radially outward direction, wherein the spiral shape causes a pulling cut when the blade is rotated, wherein the pulling cut includes at least three, better at least four centimeters cutting length per centimeter cutting depth.

5. The portioning machine according to claim 1,
wherein a contact edge for the blade (8) is arranged at an edge of the face of the forming tube revolver (1), wherein the contact edge is made from steel or from a material that sharpens the cutting edge of the blade.

6. The portioning machine according to claim 1,
wherein a rotation axis of the blade (8) and of a stop plate (9) coincides with the rotation axis (10′) of the forming tube revolver (1) and in particular both rotation drives are arranged concentric to one another on the same axis and/or
wherein a longitudinal press plunger (3) is driven by a servo cylinder (4) and can in particular move into exactly predetermined longitudinal positions which are predetermined by the control as a function of the axial distance (17) adjusted between the blade (8) and the spacer plate (9).

7. The portioning machine according to claim 1,
wherein the stop element is a stop plate (9) which is driven to rotate together with the blade (8) about an identical axis and which includes a disc cut out at least in the portion of the blade (8) and/or,
wherein the blade (8) is configured disc shaped with a surface which is larger than the surface of the cutting material (2) to be cut and/or,
wherein the blade is configured differently at a leading edge and at a trailing edge in rotation direction, in particular the blade has a different contour and/or a different grind for cutting meat on the hand side and cutting hard components like bones on the other hand side, and
wherein the rotation direction of the blade (8) is reversible.

8. The portioning machine according to claim 1,
wherein the blade (8) is supported directly at the face of the forming tube revolver (1) through
either a stable support plate (31) supporting the blade (8) on a side of the blade (8) oriented away from the forming tube revolver (1), wherein the base area of the support plate is smaller than the base area of the blade (8) and recessed inward from all cutting edges (8a, b) of the blade (8),
wherein spring elements (32) are arranged in particular on the contact surface of the support plate (21), wherein the contact surface is oriented towards the blade (8), wherein the spring elements press the blade (8) away from the support plate (31),
or magnets (33) are arranged in the face of the forming tube revolver (1), wherein the magnets continuously pull the blade (8) against the face of the forming tube revolver (1) and in particular the blade (8) has such small thickness that it does not have an inherent stability anymore which suffices for cutting,
or openings (34) that are loadable with vacuum are arranged in the face of the forming tube revolver (1) on the cutting side, wherein the openings pull the blade (8) against the face of the forming tube revolver (1) through a vacuum and in particular the blade (8) has a thickness that is small enough so that the blade (8) does not have an inherent stability which suffices for cutting.

9. The portioning machine according to claim 1,
wherein a removal device is a conveyor belt (18) which has protrusions, in particular needles on its contact surface or the conveyor belt is made from particular conveyor belts arranged adjacent to one another and protrusions, in particular needles (18) protrude in the intermediary space beyond the contact surface of the conveyor belt (18), and
wherein the rises or needles (18) are configured retractable relative to the contact surface.

10. The portioning machine according to claim 7,
wherein the stop element is a conveyor belt (18) arranged opposite to the face of the forming tube revolver (1) in the cutting position, wherein the stop element includes:
either an indentation (37) with a circumferential contour corresponding in particular to the largest circumferential contour of the forming tube openings (1a, b, c) provided in the forming tube revolver (1) and with a depth corresponding to the thickness of the blade (8), wherein the conveyor belt (18) during penetration of the blade into the cutting material (2) is moved so that a respective increasing portion of the indentation (37) is disposed under the ever increasing portion of the blade (8), wherein the portion penetrates the cross section of the forming tube opening (1a) in the cutting position,
or the conveyor belt (18) is lowered by the thickness of the blade (8) during the cutting process, either in its entirety or laterally is sequence, initially the pulley (36a) oriented towards the penetrating cutting edge (8a) and subsequently the pulley (36b) of the conveyor belt (18), wherein the pulley faces away from the cutting edge (8a), wherein the conveyor belt (18) in particular during the cutting process does not perform any feed movement, wherein the conveyor belt (18) can respectively also be a conveyor belt that is moveable back and forth.

11. The portioning machine according to claim 10,
wherein the conveyor belt (18) is adjustable with respect to its axial distance from the face of the forming tube revolver (1),
either synchronously with the adjustment of the stop element, in particular the stop plate (9),
or in a particular transmission ratio relative to the adjustment of the stop element in particular the stop plate (9),
or freely adjustable through its own control.

12. The portioning machine according to claim 1,
wherein the forming tube revolver (1) is made from plastic material and assembled from plural revolver discs (5a, b) joined in axial direction which are kept pressed together in longitudinal direction (10) through a central retaining rod (7) and which are retained in rotation direction on top of one another through fit elements that engage one another in a form locking manner so that their forming tube openings are in flush alignment and/or
wherein the retaining rod (7) is threaded at its lower end into the rotation drive of the forming tube revolver (1) and the threaded connection is disengaged from the rear upper end after rotating the retaining rod (7) and the retaining rod including an adapter disc (6) provided at the lower end of the retaining rod can be removed in upward direction, so that the forming tube revolver (1) is freely moveable in radial direction for replacement and/or,
wherein an intermediary plate (26) is arranged between the lowest revolver disc (5a) and the portion of the forming tube revolver (1) arranged there above, wherein the intermediary plate (26) only has an opening for the cutting material (2) in the cutting position (11), wherein the opening is at least twice the size of the largest forming tube opening (1a . . . ).

13. The portioning machine according to claim 12,
wherein the particular revolver discs (5a . . . ) are offset from one another with small gaps (27) there between from the portion of the forming tube openings (1a . . . ) towards the outside for air or liquid to exit from the forming tube (1a) and/or,
wherein a snap locking device for snap locking in a respective rotation position is provided between the forming tube revolver (1) and the housing (21), or a self hemming drive in particular engaging from the outside.

14. The portioning machine according to claim 1,
wherein the forming tubes respectively include a transversal press plunger (25) which forms a portion of the circumference of the forming tube openings (1a . . . ) and extends over the entire length of the forming tube revolver (1) and the transversal press plungers form portions of the outer circumference of the forming tube revolver (1) and in particular
wherein the forming tube revolver (1) is made from plastic material and from a base element with grooves that are open towards the outside and transversal press plungers (25a . . . ) inserted radially from the outside and the longitudinal press plungers (3) are configured in two components in the cross section of the forming tube with a spring between the two components, wherein one component corresponds to the inner circumferential portion of the transversal press plunger (25a).

15. The portioning machine according to claim 14,
wherein the transversal press plungers (25a . . . ) are radially moveable into the forming tube revolver (1) through a stop (28) which is in particular only provided in the cutting position (11) or through a hydraulic or servo cylinder.

16. The portioning machine according to claim 1,
wherein a control is configured to determined a length of the cutting material(2) after longitudinal compression of the cutting materials (2) and before a beginning of the cutting process and the control is configured to compute a slice thickness as a function of additional predetermined parameters, wherein the slice thickness facilitates a cutting of the cutting material with minimum leftovers, ideally without leftovers and/or,
wherein the longitudinal press plunger (3) is exchangeable at the longitudinal press cylinder, in particular at the servo cylinder (4) in adaptation to the selected cross section of the forming tube.

17. The portioning machine according to claim 1,
wherein the longitudinal press plunger (3) is one of plural plungers on a press plunger revolver which rotates synchronously with the forming tube revolver (1), preferably however about an axis which is laterally offset from the rotation axis of the forming tube revolver so that the forming tube revolver and the press plunger revolver are only in flush alignment in the cutting position (11) and a longitudinal press plunger, in particular a servo cylinder is only provided in the cutting position and/or,
wherein the longitudinal press plunger (3) is one of plural plungers which are moveable along a rail, in particular an annular rail and a partial section of the rail in the cutting position is a component of the longitudinal press cylinder and/or,
wherein a portioning plate (12) with a pass through opening for the slice to be cut off is provided at the cutting position between the stop element, in particular the stop plate (9) and the blade (8), in particular so that the portioning plate is radially insertable from the outside.

18. The portioning machine according to claim 17,
wherein the portioning plate (20) is configured as a portioning revolver (12′) with plural pass through openings distributed over its circumference with contours according to the forming tube openings in the forming tube revolver (1), and
wherein the portioning revolver (12′) rotates in particular about a rotation axis (10) which is offset from the rotation axis of the forming tube revolver (1) so that the two revolvers (1, 12) only overlap in the cutting position (11) so far that their openings are in flush alignment with one another at this location, and in particular
wherein the portioning revolver (12′) is rotated forward by one position into a drop off position after cutting and receiving each slice (2a) and the stop plate (9) arranged under the portioning revolver (12′) does not rotate with the blade (8) but remains in the cutting position (11).

19. The portioning machine according to claim 17,
wherein the portioning plate (12) includes an expansion that extends beyond the contour of the forming tube opening in the portion of its pass through opening which is reached by the cutting edge of the blade (8) last and/or,
wherein the portioning plate (12) is expandable with respect to the cross section of its pass through opening, in particular the portioning plate (12) is made from two portioning plate halves that are pivotably linked together and configured to be folded up, wherein the portioning plate halves respectively enclose half of the pass through openings like a pincer.

20. The portioning machine according to claim 1,
wherein a drive unit for rotating the forming tube revolver (1) and also for rotating the blade (8) and possibly the stop plate (9) are arranged in a housing (21) under the cutting device, wherein the forming tube revolver (1) is placed on the housing and/or,
wherein the drive unit includes a drive shaft (23) that is in flush alignment with the rotation axis of the forming tube revolver (1), wherein the drive shaft includes at least two drive tubes that extend coaxially within one another and which are rotatable independently from one another, wherein one drive shaft is used for rotating the forming tube revolver (1) and the other drive shaft is used for rotating the blade (8) and possibly the stop plate (9).

21. The portioning machine according to claim 1,
wherein a drive motors for the forming tube revolver (1) on the one hand side and for the blade (8) and the stop plate (9) on the other hand side are coaxially arranged on the drive shaft with a longitudinal offset and/or,
wherein the drive tube for the blade and the stop plate is torque proof relative to the associated drive motor and also longitudinally moveable for adjusting the slice thickness (16) and moved by a separate actuation cylinder in axial direction and/or
wherein the portioning machine includes at least two forming tube revolvers (1) arranged adjacent to one another and cutting of slices (2a) for the two forming tube revolvers is performed by a common blade (8) driven in rotation, whose rotation axis is arranged offset from the rotation axis (10′) of the particular forming tube revolvers (1).

22. A method for cutting a strand shaped cutting material (2) into slices (2a) preferably with identical volumes through a portioning machine which method comprises:
pre compression of the cutting material (2) performed through a longitudinal press plunger (3) against an intermediary plate (26) or a blade (8),
rotating the intermediary plate (26) after pre compression so that the opening of the intermediary plate (26) is in flush alignment in the cutting position (11) with the forming tube (1a) in the cutting position (11) and,
pressing the cutting material (2) in the cutting position against the stop plate (9) in longitudinal direction (10).

23. The method according to claim 22,
wherein a volume determination of the cutting material (2) is performed through position determination of the longitudinal press plunger in the forming tube (1a . . . ) during pre compression and/or during final compression.

24. The method according to one the preceding method claims claim 22,
wherein a form locking engagement of the forming tube revolver (1) with the housing (21) is performed during a rotation of the forming tube revolver (1) into a new rotation position or the rotation drive for the forming tube (1) is configured self hemming and/or,
wherein the pressure of the particular revolver discs (5a, b) relative to one another in assembled condition is selected so that air or liquid enclosed during longitudinal compression in the forming tube (1a) can exit towards the outside through the gaps between the revolver discs (5a, b).
